(19) United States
(12) Patent Application Publication
(10) Pub. No.: US 2023/0100959 A1
(43) Pub. Date: Mar. 30, 2023

(54) BLAST FURNACE SLAG GRANULATION AND WASTE HEAT RECOVERY AND UTILIZATION DEVICE AND METHOD

(71) Applicant: BAOSHAN IRON & STEEL CO., LTD., Shanghai (CN)

(72) Inventors: Yongli XIAO, Shanghai (CN); Yongqian LI, Shanghai (CN); Youping ZHANG, Shanghai (CN); Yunze GUAN, Shanghai (CN); Mengqin XIE, Shanghai (CN); Yingjie WANG, Shanghai (CN)

(73) Assignee: BAOSHAN IRON & STEEL CO., LTD., Shanghai (CN)

(21) Appl. No.: 17/802,605

(22) PCT Filed: Dec. 31, 2020
(86) PCT No.: PCT/CN2020/141914

§ 371 Date: Aug. 26, 2022

(30) Foreign Application Priority Data
Feb. 28, 2020 (CN) 202010129701.0

(51) Int. Cl. C21B 3/08; F27D 17/00; F01K 25/14; C21B 7/00

(52) U.S. Cl. CPC C21B 3/08; F27D 17/004; F01K 25/14; C21B 7/002; C21B 2400/024; C21B 2400/062; C21B 2400/08

(57) ABSTRACT

Disclosed are an apparatus and a method for granulation of a blast furnace slag and recycling of waste heat. The apparatus comprises an aerosol granulation nozzle module, a flow guide, a cyclone separator and a waste heat recovery device; wherein the aerosol granulation nozzle module comprises a slag flow controller, a compressed air flow control valve, a water volume control valve and an aerosol spray gun; the flow guide is configured to fully mix the medium temperature gas and the high-temperature granular slag having a primarily solidified surface in the flow guide; and the cyclone separator is configured to separate the high-temperature granular slag and the medium-to-high-temperature gas. The present invention completes the granulation of blast furnace slag, and organically couples slag sensible heat recovery with sludge drying, thereby recovering the waste heat in the process of slag granulation and improving the efficiency of waste heat recovery and utilization.

### TECHNICAL FIELD

The present disclosure relates to an apparatus and method for treating a metallurgical slag, in particular to an apparatus and method for granulation of a blast furnace slag and recycling of waste heat.

### BACKGROUND ART

Blast furnace slag is the main by-product of blast furnace ironmaking. One ton iron is accompanied by about 350 kg blast furnace slag. The temperature of blast furnace slag leaving the furnace is 1450° C. to 1550° C. The sensible heat ((1260−1880)×10³ kJ) carried by one ton slag is equivalent to the heat generated by 60 kg standard coal, so recovery of the sensible heat is very valuable.

Nowadays, blast furnace slag is treated mostly by a water quenching process in which the furnace slag is flushed with high-pressure water and forms water slag, and accordingly, the high-value sensible heat is transferred to the water slag and wastewater having a temperature of about 80° C., losing its value for recovery. In addition, 0.4 to 0.5 tons of water is consumed for treatment of one ton of slag, and a large quantity of waste steam rich in H₂S, SO₂ and other pollutants is emitted at the same time. For subsequent resource utilization (such as micronization), 8-15% of the water in the water slag needs to be dried off by consuming about 1000 m³ of hot air having a temperature of 500° C. per ton slag, leading to waste of a large amount of resources.

Blast furnace slag is a high-temperature melt formed from gangue in an ore, ash in a fuel and non-volatile components in a solvent (usually limestone) during blast furnace ironmaking. Said high temperature is about 1450° C. The main components of the blast furnace slag include silicon dioxide (SiO₂), aluminum oxide (Al₂O₃), calcium oxide (CaO), magnesium oxide (MgO), manganese oxide (MnO), iron oxide (FeO) and sulfur, etc., wherein the mass ratio of silicon dioxide (SiO₂) and aluminum oxide (Al₂O₃) to calcium oxide (CaO) and magnesium oxide (MgO) is about 0.8-1.2. Therefore, blast furnace slag is characterized by a low coefficient of heat conductivity and sharp increase in viscosity with decreasing temperature, resulting in slow heat transfer of blast furnace slag and high difficulty in waste heat recovery.

Rapid dry granulation of slag particles can provide conditions for heat recovery. Nowadays, the processes for rapid dry granulation of slag mainly include air granulation and centrifugal granulation. The air granulation process has not been put into practice widely in the field of blast furnace slag treatment due to its high noise and easy generation of slag wool. It is only suitable for treatment of some steel slag with good fluidity. For centrifugal granulation, a rotating disc or a rotating cup is mainly used as a granulator which makes use of centrifugal force to disperse and break the slag into fine droplets to facilitate rapid cooling, so that the glass phase content and activity of the cooled slag particles meet the requirements of a slag micropowder raw material. However, there are problems such as slag crusting, nonuniform particle size of the granulated slag particles, and easy generation of slag wool.

Chinese Invention Patent ZL 201410755689.9 discloses a system and method for recovering waste heat from high-temperature slag. The apparatus includes a slag conveying unit, a slag granulation unit and a waste heat recovery unit. It can recover the sensible heat of the high-temperature slag. However, during recovery of the waste heat, the slag is transported in a slag tank over a long distance, and it is easy to cool down. So, additional heat needs to be supplemented. The energy consumption is high, and the recovery efficiency of the waste heat is low.

Chinese Invention Patent ZL 201010566938.1 discloses a system for dry granulation of metallurgical slag and recovery of heat energy. The liquid slag is dry granulated by centrifugal rotation and airflow pulse. Airflow nozzles and atomized water nozzles are respectively arranged annularly around the rotating shaft of a centrifugal rotating disk under the centrifugal rotating disk. A watercooling wall is provided at the inner side wall of the dry granulation apparatus. A fluidized device with an annular conical surface is provided under the water-cooling wall, and an annular fluidized bed is provided at the bottom of the dry granulation apparatus. The utilization of the waste heat recovered from the slag according to this invention patent is limited to conversion into steam with hot air/nitrogen or power generation, and the efficiency is low.

As a kind of solid waste, sludge has become the second largest source of solid waste pollution after urban waste pollution. The traditional methods for treating sludge mainly include landfill, incineration, sea discharge, and agricultural use. In the field of sewage treatment involving industrial sewage, domestic sewage or the like, sludge treatment is also commonly involved. Along with the technological development, the prior art processes for sludge treatment include fermentation, melting, addition of lime, carbonization, etc. However, the equipment cost and energy consumption are very high, the treatment efficiency is low, and secondary pollution to air and water sources may be caused.

### SUMMARY

One object of the present disclosure is to provide an apparatus and method for granulation of a blast furnace slag and recycling of waste heat, by which full granulation of blast furnace slag is achieved, wherein recovery of sensible heat of the slag is coupled organically with drying of sludge and preparation of steam and hot water, so that waste heat is recovered from medium-to-high-temperature gas and high-temperature granular slag in the process of slag granulation, thereby greatly improving the efficiency of recovery and utilization of waste heat.

The above object of the present disclosure is realized in the following way:

An apparatus for granulation of a blast furnace slag and recycling of waste heat, wherein the apparatus comprises an aerosol granulation nozzle module, a flow guide, a cyclone separator and a waste heat recovery device;

wherein the aerosol granulation nozzle module comprises a slag flow controller, a compressed air flow control valve, a water volume control valve and an aerosol spray gun; wherein the slag flow controller is coupled to a slag inlet of the flow guide; the compressed air flow control valve is coupled to a gas inlet of the aerosol spray gun; the water volume control valve is coupled to a liquid inlet of the aerosol spray gun; wherein a nozzle of the aerosol spray gun is configured to face an inlet of the flow guide to enable an aerosol to impinge a slag stream entering the flow guide through the slag flow controller to form a medium temperature gas and a high-temperature granular slag having a primarily solidified surface;

wherein the flow guide is configured to fully mix the medium temperature gas and the high-temperature granular slag having a primarily solidified surface in the flow guide, wherein an outlet of the flow guide is coupled to a feed port of the cyclone separator to allow for entry of a completely solidified high-temperature granular slag and a medium-to-high-temperature gas formed in the flow guide into the cyclone separator;

wherein the cyclone separator is configured to separate the high-temperature granular slag and the medium-to-high-temperature gas; wherein a discharge port of the cyclone separator is coupled to a feed port of the waste heat recovery device for delivery of the medium-to-high-temperature gas and the completely solidified high-temperature granular slag to the waste heat recovery device.

In some embodiments, the present disclosure provides an apparatus for granulation of a blast furnace slag and recycling of waste heat, wherein the apparatus comprises an aerosol granulation nozzle module, a flow guide, a cyclone separator and a waste heat recovery device;

wherein the aerosol granulation nozzle module comprises a slag flow controller, a compressed air flow control valve, a water volume control valve and an aerosol spray gun; wherein a slag stream is subjected to flow control by the slag flow controller and flows into a slag inlet of the flow guide; a high pressure gas is directed to a gas inlet of the aerosol spray gun through the compressed air flow control valve; water is directed to a liquid inlet of the aerosol spray gun through the water volume control valve; wherein a nozzle of the aerosol spray gun is configured to face an inlet of the flow guide to enable an aerosol to impinge the slag stream to form a medium-temperature gas and a high-temperature granular slag having a primarily solidified surface;

wherein an outlet of the flow guide is coupled to a feed port of the cyclone separator, wherein the medium-temperature gas and the high-temperature granular slag having a primarily solidified surface are fully mixed in the flow guide to form a completely solidified high-temperature granular slag and a medium-to-high-temperature gas which then enter the cyclone separator for separation of the high-temperature granular slag and the medium-to-high-temperature gas by the cyclone separator; wherein a discharge port of the cyclone separator is coupled to a feed port of the waste heat recovery device for delivery of the medium-to-high-temperature gas and the completely solidified high-temperature granular slag to the waste heat recovery device.

After formed by impinging the aerosol from the aerosol granulation nozzle module on the slag stream, the medium-temperature gas has a temperature of 200-400° C., and the high-temperature granular slag having a preliminarily solidified surface has a temperature of 1000-1200° C.; wherein after mixed in the flow guide, the medium-to-high temperature gas has a temperature of 300-500° C., and the completely solidified high-temperature granular slag has a temperature of 800-1100° C.; wherein after separated by the cyclone separator, the high-temperature granular slag has a temperature of 700-950° C., and the medium-to-high temperature gas has a temperature of 350-550° C.

The waste heat recovery device is a sludge drying module comprising a screw mixer, a sludge dryer, a sludge pre-drying module, a slag-sludge recovery module and a tail gas treatment module. The discharge port of the cyclone separator is coupled to a first feed port of the screw mixer to transport the completely solidified high-temperature granular slag into the screw mixer. An aerosol port of the cyclone separator is coupled to an aerosol port of the sludge pre-drying module to transport the medium-to-high-temperature gas into the sludge pre-drying module, so that the medium-to-high-temperature gas is mixed with the wet sludge in the sludge pre-drying module to form a semi-dry sludge. A discharge port of the sludge pre-drying module is coupled to a second feed port of the screw mixer to transport the semi-dry sludge into the screw mixer, so that the semi-dry sludge and the high-temperature granular slag are mixed in the screw mixer to form a slag-sludge mixture. A discharge port of the screw mixer is coupled to a feed port of the sludge dryer to transport the slag-sludge mixture into the sludge dryer. A discharge port of the sludge dryer is coupled to a feed port of the slag-sludge recovery module to transport the dry sludge powder and slag granules into the slag-sludge recovery module. A gas inlet of the tail gas treatment module is coupled to a gas outlet of the sludge pre-drying module, a gas outlet of the sludge dryer and a gas outlet of the slag-sludge recovery module respectively.

The waste heat recovery device is a high-temperature steam preparation module. The high-temperature steam preparation module is coupled to the cyclone separator to recover heat of the medium-to-high-temperature gas and the high-temperature granular slag to prepare a high-temperature steam having a temperature of 200-250° C. The high-temperature steam is incorporated into a pipe network for use at the same level or for power generation. A tail gas outlet of the high-temperature steam preparation module is coupled to a tail gas treatment module.

In some embodiments, the high-temperature steam preparation module comprises a slag bin, a tail gas treatment device, a gas purifier, an exhauster, a chimney, a high-temperature feed conveyor, a high-temperature granular slag heat exchanger, a boiler and an economizer;

wherein the high-temperature feed conveyor is provided between the discharge port of the cyclone separator and a feed port of the high-temperature granular slag heat exchanger to transport the high-temperature granular slag separated by the cyclone separator to an upper part of the high-temperature granular slag heat exchanger; a coil containing circulating water is provided in the high-temperature granular slag heat exchanger for reverse heat exchange of the high-temperature granular slag with this coil and a gas stream rising from bottom to top; the slag bin is provided under a discharge port located at a bottom of the high-temperature granular slag heat exchanger to receive the cooled granular slag; a top of the high-temperature granular slag heat exchanger is provided with a gas port which is coupled to the boiler; the economizer is coupled to the boiler and the high-temperature granular slag heat exchanger respectively, so that pure water sent to the economizer through an external pipe network is preheated to 80° C. or higher by a tail gas emitted from the boiler, and divided into two parts, one part being sent into the boiler, and the other part entering the coil of the high-temperature granular slag heat exchanger to absorb heat of the high-temperature granular slag; a gas inlet of the tail gas treatment device is coupled to a tail gas outlet of the economizer, a gas outlet of the tail gas treatment device is coupled to a gas inlet of the tail gas purifier, and a gas outlet of the tail gas purifier is coupled to the chimney through the exhauster for purification and discharge of the tail gas.

In some embodiments, when the water in the coil vaporizes and its temperature rises to about 250° C., it enters a steam drum at an upper part of the boiler, where it is mixed with steam generated by the boiler itself and incorporated into an external pipe network.

The waste heat recovery device is a low-temperature hot water preparation module. The low-temperature hot water preparation module is coupled to the cyclone separator to recover heat of the medium-to-high-temperature gas and the high-temperature granular slag to prepare low-temperature hot water having a temperature of 70-95° C. The low-temperature hot water is delivered to a user for use at the same level or for a cooling purpose. A tail gas outlet of the low-temperature hot water preparation module is coupled to a tail gas treatment module.

In some embodiments, the low-temperature hot water preparation module comprises a slag bin, a tail gas treatment device, a gas purifier, an exhauster, a chimney, a high-temperature feed conveyor, a high-temperature granular slag heat exchanger and a boiler;

wherein the high-temperature feed conveyor is provided between the discharge port of the cyclone separator and a feed port of the high-temperature granular slag heat exchanger to transport the high-temperature granular slag separated by the cyclone separator to an upper part of the high-temperature granular slag heat exchanger; a coil containing circulating water is provided in the high-temperature granular slag heat exchanger for reverse heat exchange of the high-temperature granular slag with this coil and a gas stream rising from bottom to top; the slag bin is provided under a discharge port located at a bottom of the high-temperature granular slag heat exchanger to receive the cooled granular slag; a top of the high-temperature granular slag heat exchanger is provided with a gas port which is coupled to the boiler; the boiler and the high-temperature granular slag heat exchanger are coupled to an external pipe network respectively to receive pure water for heat exchange in the boiler and the high-temperature granular slag heat exchanger; a gas inlet of the tail gas treatment device is coupled to a tail gas outlet of the boiler, a gas outlet of the tail gas treatment device is coupled to a gas inlet of the tail gas purifier, and a gas outlet of the tail gas purifier is coupled to the chimney through the exhauster for purification and discharge of the tail gas.

The tail gas treatment module comprises a tail gas treatment device, a tail gas purifier, an exhauster and a chimney. The gas inlet of the tail gas treatment device is coupled to a gas outlet of the sludge pre-drying module, a gas outlet of the sludge dryer, a gas outlet of the slag-sludge recovery module, a tail gas outlet of the boiler and a tail gas outlet of the economizer through pipes respectively. The gas outlet of the tail gas treatment device is coupled to the gas inlet of the tail gas purifier, and the gas outlet of the tail gas purifier is coupled to the chimney through the exhauster.

A method for granulation of a blast furnace slag and recycling of waste heat, comprising the following steps:

Step 1: allowing a blast furnace slag separated from molten iron to enter a slag runner where a slag stream is formed and flows into a flow guide after its flow is controlled by a slag flow controller;

Step 2: adjusting a compressed air flow control valve and a water volume control valve to form a high-pressure aerosol in an aerosol spray gun and spray the high-pressure aerosol out through a nozzle, so that the high-pressure aerosol impinges the slag stream flowing into the flow guide to form a medium-temperature gas and a high-temperature granular slag having a preliminarily solidified surface;

Step 3: mixing and heat exchanging the medium-temperature gas and the high-temperature granular slag having a preliminarily solidified surface through the flow guide to form a completely solidified high-temperature granular slag and a medium-to-high-temperature gas which are transported to a cyclone separator by which the high-temperature granular slag and the medium-to-high-temperature gas are separated;

Step 4: transporting the medium-to-high-temperature gas and the high-temperature granular slag to a waste heat recovery device from the cyclone separator, wherein heat of the medium-to-high-temperature gas and the high-temperature granular slag is recovered by the waste heat recovery device and used for sludge drying, high-temperature steam preparation, power generation or low-temperature hot water preparation.

In some embodiments, in the method, after formed by impinging the aerosol from the aerosol granulation nozzle module on the slag stream, the medium-temperature gas has a temperature of 200-400° C., and the high-temperature granular slag having a preliminarily solidified surface has a temperature of 1000-1200° C. After mixed in the flow guide, the medium-to-high temperature gas has a temperature of 300-500° C., and the completely solidified high-temperature granular slag has a temperature of 800-1100° C. After separated by the cyclone separator, the high-temperature granular slag has a temperature of 700-950° C., and the medium-to-high temperature gas has a temperature of 350-550° C.

In some embodiments, the step of sludge drying comprises:

Step 4.1.1: pumping a wet sludge from a sludge tank with a sludge pump into a sludge pre-dryer;

Step 4.1.2: mixing and reversely heat exchanging the wet sludge with the medium-to-high-temperature gas in the sludge pre-dryer to form a semi-dry sludge;

Step 4.1.3: transporting the semi-dry sludge from the sludge pre-drying module to a screw mixer, and transporting the high-temperature granular slag from the cyclone separator to the screw mixer, wherein the semi-dry sludge and the high-temperature granular slag are mixed by the screw mixer to form a slag-sludge mixture;

Step 4.1.4: transporting the slag-sludge mixture from the screw mixer to a sludge dryer, wherein the sludge dryer dries the slag-sludge mixture into a dry sludge powder and slag granules which are transported to a slag-sludge recovery module;

Step 4.1.5: separating the dry sludge powder from the slag granules in a slag-sludge separator of the slag-sludge recovery module;

Step 4.1.6: transporting the dry sludge powder from the sludge separator to a dry sludge powder bin for temporary storage;

Step 4.1.7: transporting the slag granules from the sludge separator to a slag bin for temporary storage.

The method further comprises purifying and discharging the wet tail gas with a tail gas treatment module, including: collecting and pretreating the wet tail gas from the sludge pre-dryer, the sludge dryer and the slag-sludge separator with a tail gas treatment device of the tail gas treatment module, followed by deep purification with a tail gas purifier, wherein the up-to-standard purified tail gas is discharged through a chimney by an exhauster; and the fine powder collected in the tail gas treatment device and the tail gas purifier is extracted out with an external tanker.

In some embodiments, the step of high-temperature steam preparation comprises:

Step 4.2.1: transporting the high-temperature granular slag from the cyclone separator to a high-temperature granular slag conveyor which lifts the high-temperature granular slag and feeds it evenly to a high-temperature granular slag heat exchanger from an upper inlet of the high-temperature granular slag heat exchanger, wherein the high-temperature granular slag moves from top to bottom, and in the process of descending, it contacts and exchanges heat countercurrently with the cooling water in the coil and the air rising from bottom to top;

Step 4.2.2: discharging the heated steam from a top of the high-temperature granular slag heat exchanger and sending it to a boiler, and discharging the cooled granular slag from a lower part of the high-temperature granular slag heat exchanger to a slag bin;

Step 4.2.3: sending pure water from an external pipe network to an economizer to be preheated to 80° C. or higher by a tail gas discharged from the boiler, wherein one part of the preheated pure water is sent to the boiler to be further heated and vaporized into steam having a temperature of 200-250° C., and the other part enters the coil of the high-temperature granular slag heat exchanger to absorb the heat of the high-temperature granular slag;

Step 4.2.4: sending the water in the coil to a steam drum at an upper part of the boiler after it is vaporized and heated to about 250° C., wherein it is mixed with the steam generated in the boiler itself and then integrated into the external pipe network.

In some embodiments, the step of low-temperature hot water preparation comprises:

Step 4.3.1: transporting the high-temperature granular slag from the cyclone separator to a high-temperature granular slag conveyor which lifts the high-temperature granular slag and feeds it evenly to a high-temperature granular slag heat exchanger from an upper inlet of the high-temperature granular slag heat exchanger, wherein the high-temperature granular slag moves from top to bottom, and in the process of descending, it contacts and exchanges heat countercurrently with the cooling water in the coil and the air rising from bottom to top;

Step 4.3.2: discharging the heated low-temperature hot water having a temperature of 70-95° C. from a top of the high-temperature granular slag heat exchanger and sending it to the boiler, and discharging the cooled granular slag from a lower part of the high-temperature granular slag heat exchanger to a slag bin;

Step 4.3.3: sending one part of pure water from an external pipe network to the boiler to be heated to 70-95° C. by a gas passing through the boiler, and sending the other part to the coil of the high-temperature granular slag heat exchanger to absorb the heat of the high-temperature granular slag;

Step 4.3.4: sending the water in the coil to a steam drum at an upper part of the boiler after it is heated by absorbing the heat, wherein it is mixed with the hot water generated in the boiler itself and then integrated into the external pipe network.

In some embodiments, the method further comprises purifying and discharging the wet tail gas with a tail gas treatment module, including: collecting and pretreating the wet tail gas from the sludge pre-dryer, the sludge dryer and the slag-sludge separator with a tail gas treatment device of the tail gas treatment module, followed by deep purification with a tail gas purifier, wherein the up-to-standard purified tail gas is discharged through a chimney by an exhauster; and the fine powder collected in the tail gas treatment device and the tail gas purifier is extracted out with an external tanker.

Compared with the prior art, the present disclosure shows the following beneficial effects:

1. With the use of the apparatus for granulation of a blast furnace slag and recycling of waste heat according to the present disclosure, the blast furnace slag is impinged by an aerosol and cyclone separated to form a completely solidified high-temperature granular slag and a medium-to-high-temperature gas. The granular slag has a uniform particle size, and formation of slag wool during granulation is avoided. The separated high-temperature granular slag and medium-to-high-temperature gas can be used directly in each step of sludge drying with high waste heat recovery efficiency, and can also be used for high-temperature steam power generation, hot water recovery, etc.

2. The apparatus for granulation of a blast furnace slag and recycling of waste heat according to the present disclosure organically couples recovery of the sensible heat of the slag with drying of the sludge. The blast furnace slag is granulated rapidly and safely while the sludge is dried efficiently. This not only improves the waste heat recycling efficiency greatly, but also reduces the waste heat recovery cost. The problem of low efficiency and high cost for drying sludge is solved.

3. In the method for granulation of a blast furnace slag and recycling of waste heat according to the present disclosure, the blast furnace slag is completely granulated into a high-temperature granular slag suitable for waste heat recovery with high efficiency. By recovering the waste heat of the medium-to-high-temperature gas and the high-temperature granular slag, the sensible heat of the slag is utilized at the same level to the maximum extent, and better economic and social benefits are produced.

In summary, full granulation of a blast furnace slag is realized according to the present disclosure, and a uniform particle size is achieved. Recovery of the sensible heat of the slag and drying of the sludge are combined organically, so that the waste heat of the medium-to-high-temperature gas and high-temperature granular slag is recovered in the process of slag treatment. The efficiency of recycling the waste heat is improved greatly, and good economic and social benefits are achieved. The apparatus and method can be popularized and applied in the field of slag treatment for blast furnaces of various sizes and have broad prospects.

### DESCRIPTION OF THE DRAWINGS

FIG. 1 is a process flow diagram for Example 1 of the apparatus for granulation of a blast furnace slag and recycling of waste heat according to the present disclosure;

FIG. 2 is a process flow diagram for Example 2 of the apparatus for granulation of a blast furnace slag and recycling of waste heat according to the present disclosure;

FIG. 3 is a process flow diagram for Example 3 of the apparatus for granulation of a blast furnace slag and recycling of waste heat according to the present disclosure;

FIG. 4 is a flow diagram of the method for granulation of a blast furnace slag and recycling of waste heat according to the present disclosure. In the figures, the dashed line represents a pipeline for conveying a gas stream, and the solid line represents a pipeline for conveying slag granules.

In the figures, 1 slag stream, 2 slag flow controller, 3 compressed air flow control valve, 4 water volume control valve, 5 aerosol spray gun, 6 slag granules, 7 flow guide, 8 cyclone separator, 9 screw mixer, 10 sludge dryer, 11 slag bin, 12 dry sludge powder bin, 13 slag-sludge separator, 14 sludge pre-dryer, 15 sludge pump, 16 sludge tank, 17 tail gas treatment device, 18 tail gas purifier, 19 exhauster, 20 chimney, 21 high-temperature feed conveyor, 22 high-temperature granular slag heat exchanger, 23 boiler, 24 economizer.

### DETAILED DESCRIPTION

The invention will be further illustrated with reference to the accompanying drawings and the specific embodiments.

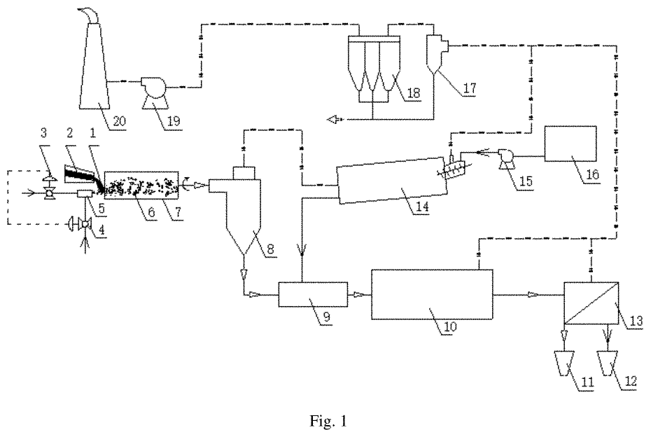

See FIG. 1 which shows an apparatus for granulation of a blast furnace slag and recycling of waste heat, comprising an aerosol granulation nozzle module, a flow guide 7, a cyclone separator 8 and a waste heat recovery device.

The aerosol granulation nozzle module comprises a slag flow controller 2, a compressed air flow control valve 3, a water volume control valve 4 and an aerosol spray gun 5. The flow of a slag stream 1 is controlled by the slag flow controller 2, and then the slag stream 1 flows into a slag inlet of the flow guide 7. A high-pressure gas flows through the compressed air flow control valve 3 and enters a gas inlet of the aerosol spray gun 5. A small amount of water flows through the water volume control valve 4 and enters a liquid inlet of the aerosol spray gun 5. The nozzle of the aerosol spray gun 5 is configured to face the inlet of the flow guide 7, and the slag stream 1 is impinged by the aerosol to form a medium-temperature gas and a high-temperature granular slag 6 having a primarily solidified surface. The aerosol granulation nozzle module uses a high-pressure gas and a small amount of water to crash, granulate, and rapidly cool the blast furnace slag, such that the temperature of the blast furnace slag is rapidly decreased from 1450° C. to 1000-1200° C., preferably 1100° C., and the surface of the blast furnace slag is solidified primarily. The particle size of the granular slag is uniform.

The outlet of the flow guide 7 is coupled to the feed port of the cyclone separator 8. The medium-temperature gas and the high-temperature granular slag 6 having a primarily solidified surface are fully mixed in the flow guide to form a completely solidified high-temperature granular slag 6 and a medium-to-high-temperature gas which then enter the cyclone separator 8 by which the high-temperature granular slag 6 is separated from the medium-to-high-temperature gas. The discharge port of the cyclone separator 8 is coupled to the feed port of the waste heat recovery device, and the medium-to-high-temperature gas and the completely solidified high-temperature granular slag 6 are transported into the waste heat recovery device. The high-temperature granular slag 6 having a primarily solidified surface and the medium-temperature gas are fully mixed in the flow guide 7 and enter the cyclone separator 8 for full mixing and heat exchange, so that the high-temperature granular slag 6 is completely solidified, and formation of slag wool is avoided. It is more conducive to the recovery of heat. At the same time, separation of the medium-to-high-temperature gas stream and the high-temperature granular slag 6 is accomplished. The temperature of the separated high-temperature granular slag 6 is decreased to 700-950° C., preferably 800-850° C., favorable for the waste heat recovery module to recycle the waste heat.

The temperature of the slag stream 1 is 1450-1550° C. The temperature of the medium-temperature gas formed by impinging the aerosol from the aerosol granulation nozzle module on the slag stream 1 is 200-400° C. The temperature of the high-temperature granular slag 6 having a preliminarily solidified surface is 1000-1200° C., preferably 1100° C. The temperature of the medium-to-high-temperature gas mixed by the flow guide 7 is 300-500° C., preferably 400° C. The temperature of the completely solidified high-temperature granular slag 6 is 800-1100° C., preferably 950° C. After separated by the cyclone separator 8, the temperature of the high-temperature granular slag 6 is 700-950° C., preferably 800-850° C., and the temperature of the medium-to-high-temperature gas is 350-550° C.

The waste heat recovery device is a sludge drying module which can be used for drying sludge directly. The problem that sludge treatment is difficult and energy consuming is solved. The sludge drying module comprises a screw mixer 9, a sludge dryer 10, a sludge pre-drying module, a slag-sludge recovery module and a tail gas treatment module. The discharge port of the cyclone separator 8 is coupled to a first feed port of the screw mixer 9 to transport the completely solidified high-temperature granular slag 6 into the screw mixer 9. An aerosol port of the cyclone separator 8 is coupled to an aerosol port of the sludge pre-drying module to transport the medium-to-high-temperature gas into the sludge pre-drying module, so that the medium-to-high-temperature gas is mixed with the wet sludge in the sludge pre-drying module to form a semi-dry sludge. A discharge port of the sludge pre-drying module is coupled to a second feed port of the screw mixer 9 to transport the semi-dry sludge into the screw mixer 9, so that the semi-dry sludge and the completely solidified high-temperature granular slag 6 are mixed in the screw mixer 9 to form a slag-sludge mixture. A discharge port of the screw mixer 9 is coupled to a feed port of the sludge dryer 10 to transport the slag-sludge mixture into the sludge dryer 10. The slag-sludge mixture is further mixed and dried in the sludge dryer 10 to form a dry sludge powder and low-temperature slag granules. A discharge port of the sludge dryer 10 is coupled to a feed port of the slag-sludge recovery module to transport the dry sludge powder and slag granules into the slag-sludge recovery module. A gas inlet of the tail gas treatment module is coupled to a gas outlet of the sludge pre-drying module, a gas outlet of the sludge dryer 10 and a gas outlet of the slag-sludge recovery module.

The sludge pre-drying module comprises a sludge pre-dryer 14, a sludge pump 15 and a sludge tank 16. The discharge port of the sludge tank 16 is coupled to the feed port of the sludge pre-dryer 14 through a pipeline on which the sludge pump 15 is provided, such that the wet sludge in the sludge tank 16 is transported into the sludge pre-dryer 14. The sludge pre-dryer 14 is provided with an aerosol port which is coupled to the aerosol port of the cyclone separator 8. The aerosol port and the feed port of the sludge pre-dryer 14 are located at the two ends of the sludge pre-dryer 14 respectively, so that the medium-to-high-temperature gas and the sludge move in opposite directions, and reverse heat exchange occurs between them. The contact area between the medium-to-high-temperature gas and the sludge is large, and they are mixed fully with high heat exchange efficiency. The sludge pre-dryer 14 is provided with a gas outlet which is coupled to the gas inlet of the tail gas treatment module. The wet sludge in the sludge tank 16 is pumped into the sludge pre-dryer 14 by the sludge pump 15, and exchanges heat with the medium-to-high-temperature gas in the sludge pre-dryer 14 to form a semi-dry sludge.

The slag-sludge recovery module comprises a slag bin 11, a dry sludge powder bin 12 and a slag-sludge separator 13. The slag-sludge separator 13 is provided with a feed port, two discharge ports, and a gas outlet. The discharge port of the sludge dryer 10 is coupled to the feed port of the slag-sludge separator 13. The two discharge ports of the slag-sludge separator 13 are coupled to the slag bin 11 and the dry sludge powder bin 12 respectively. The gas inlet of the tail gas treatment module is coupled to the gas outlet of the slag-sludge separator 13. The mixture of the dry sludge powder and the slag granules enters the slag-sludge separator 13 and then is separated by the slag-sludge separator 13. The dry sludge powder is temporarily stored in the dry sludge powder bin 12, and the slag granules are temporarily stored in the slag bin 11, which can facilitate later recovery and treatment. The wet tail gas in the slag-sludge separator 13 enters the tail gas treatment module.

The tail gas treatment module comprises a tail gas treatment device 17, a tail gas purifier 18, an exhauster 19 and a chimney 20. The gas inlet of the tail gas treatment device 17 is coupled to the gas outlet of the sludge pre-dryer 14 in the sludge pre-drying module, the gas outlet of the sludge dryer 10, the gas outlet of the slag-sludge separator 13 in the slag-sludge recovery module, the tail gas outlet of the boiler 23 and the tail gas outlet of the economizer 24 through pipes respectively. The gas outlet of the tail gas treatment device 17 is coupled to the gas inlet of the tail gas purifier 18. The gas outlet of the tail gas purifier 18 is coupled to the chimney 20 through the exhauster 19. The tail gas treatment device 17 collects the wet tail gas and purifies it primarily. The primarily purified tail gas is sent to the tail gas purifier 18 for deep purification, and then discharged through the chimney 20 by the exhauster 19.

Discharged ports are provided at the lower parts of both the tail gas treatment device 17 and the tail gas purifier 18. The discharge port can be coupled externally to a tanker through a pipe. The external tanker can extract the small amount of fine powder that is filtered from the tail gas treatment device 17 and the tail gas purifier 18, so as to ensure normal operation of the tail gas treatment device 17 and the tail gas purifier 18, and also facilitate later use and treatment of the fine powder.

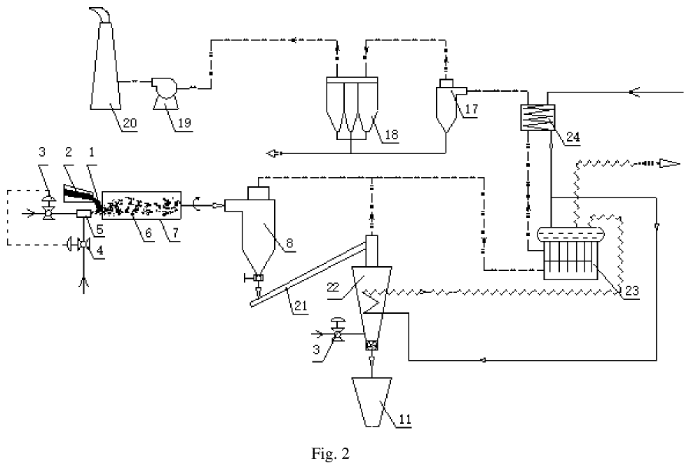

Referring to FIG. 2, the waste heat recovery device is a high-temperature steam preparation module which can be used to prepare high-temperature steam for power generation. The high-temperature steam preparation module is coupled to the cyclone separator 8 and recovers the heat of the medium-to-high-temperature gas and the high-temperature granular slag 6 to produce a high-temperature steam having a temperature of 200-250° C. The high-temperature steam is incorporated into a pipe network for use at the same level or for power generation. The tail gas outlet of the economizer 24 of the high-temperature steam preparation module is coupled to the tail gas treatment module.

The high-temperature steam preparation module comprises a slag bin 11, a tail gas treatment device 17, a tail gas purifier 18, an exhauster 19, a chimney 20, a high-temperature feed conveyor 21, a high-temperature granular slag heat exchanger 22, a boiler 23 and an economizer 24. The high-temperature feed conveyor 21 is provided between the discharge port of the cyclone separator 8 and the feed port of the high-temperature granular slag heat exchanger 22. The high-temperature granular slag 6 separated by the cyclone separator 8 is conveyed by the high-temperature feed conveyor 21 to the upper part of the high-temperature granular slag heat exchanger 22 and descends slowly. A coil containing circulating water is provided in the high-temperature granular slag heat exchanger 22. The high-temperature granular slag 6 undergoes reverse heat exchange with the coil and the gas stream rising from bottom to top, and is thus cooled down to 100° C. The slag bin 11 is provided below the discharge port disposed at the bottom of the high-temperature granular slag heat exchanger 22. The cooled granular slag is sent to the slag bin 11 for later treatment. A gas port is provided at the top of the high-temperature granular slag heat exchanger 22, and is coupled to the boiler 23. The economizer 24 is coupled to the boiler 23. Pure water is sent from an external pipe network to the economizer 24, and is preheated by the low-to-medium temperature tail gas (below 250° C.) discharged from the boiler 23 to 80° C. or higher. One part of the preheated pure water is sent to the boiler 23 to be further heated and vaporized into a high-temperature steam (200-250° C.), and the other part enters the coil of the high-temperature granular slag heat exchanger 22 to absorb the heat of the high-temperature granular slag 6. When the water in the coil is vaporized and heated to about 250° C., it enters a steam drum disposed at the upper part of the boiler 23, is mixed with the steam generated by the boiler 23 itself, and is then integrated into the external pipe network for use at the same level or for power generation. The gas inlet of the tail gas treatment device 17 is coupled to the tail gas outlet of the economizer 24. The gas outlet of the tail gas treatment device 17 is coupled to the gas inlet of the tail gas purifier 18. The gas outlet of the tail gas purifier 18 is coupled to the chimney 20 through the exhauster 19 for tail gas purification and discharge.

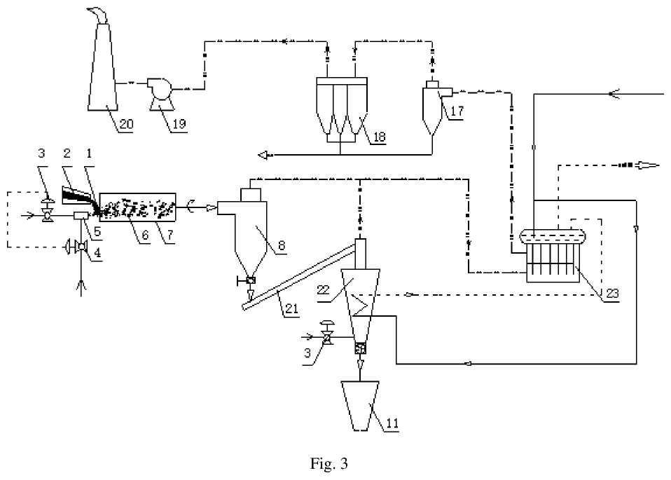

Referring to FIG. 3, the waste heat recovery device is a low-temperature hot water preparation module which can be used to prepare domestic hot water. The low-temperature hot water preparation module is coupled to the cyclone separator 8 and recovers the heat of the medium-to-high-temperature gas and the high-temperature granular slag 6 to prepare low-temperature hot water having a temperature of 70-95° C. The low-temperature hot water is supplied to a user for use at the same level or for a cooling purpose. The tail gas outlet of the boiler 23 in the low-temperature hot water preparation module is coupled to the tail gas treatment module.

The low-temperature hot water preparation module comprises a slag bin 11, a tail gas treatment device 17, a tail gas purifier 18, an exhauster 19, a chimney 20, a high-temperature feed conveyor 21, a high-temperature granular slag heat exchanger 22 and a boiler 23. The high-temperature feed conveyor 21 is provided between the discharge port of the cyclone separator 8 and the feed port of the high-temperature granular slag heat exchanger 22. The high-temperature granular slag 6 separated by the cyclone separator 8 is conveyed by the high-temperature feed conveyor 21 to the upper part of the high-temperature granular slag heat exchanger 22 and descends slowly. A coil containing circulating water is provided in the high-temperature granular slag heat exchanger 22. The high-temperature granular slag 6 undergoes reverse heat exchange with the coil and the gas stream rising from bottom to top, and is thus cooled down to 200° C. or lower. The slag bin 11 is provided below the discharge port disposed at the bottom of the high-temperature granular slag heat exchanger 22. The cooled granular slag is sent to the slag bin 11 for later treatment. A gas port is provided at the top of the high-temperature granular slag heat exchanger 22, and is coupled to the waste heat boiler 23. One part of the pure water supplied from an external pipe network is sent to the boiler 23 to be heated to 70-95° C., and the other part enters the coil of the high-temperature granular slag heat exchanger 22 to absorb the heat of the high-temperature granular slag 6. After the water in the coil absorbs heat and is thus heated to a higher temperature, it enters a steam drum disposed at the upper part of the boiler 23, is mixed with the hot water generated by the boiler 23 itself, and is then integrated into the external pipe network for use as domestic water or for a cooling purpose. The gas inlet of the tail gas treatment device 17 is coupled to the tail gas outlet of the boiler 23. The gas outlet of the tail gas treatment device 17 is coupled to the gas inlet of the tail gas purifier 18. The gas outlet of the tail gas purifier 18 is coupled to the chimney 20 through the exhauster 19 for tail gas purification and discharge.

Here, the tail gas purifier 18 may be a cloth bag or an electrostatic deduster.

Referring to FIG. 1, the cyclone separator 8 is provided with a feed port, a discharge port and an aerosol port. The feed port of the cyclone separator 8 is coupled to the discharge port of the flow guide 7. The discharge port of the cyclone separator 8 is coupled to the first feed port of the screw mixer 9, and the aerosol port of the cyclone separator 8 is coupled to the aerosol port of the sludge pre-dryer 14 of the sludge pre-drying module. The high-temperature granular slag 6 and the medium-to-high-temperature gas can be separated efficiently by cyclone separation.

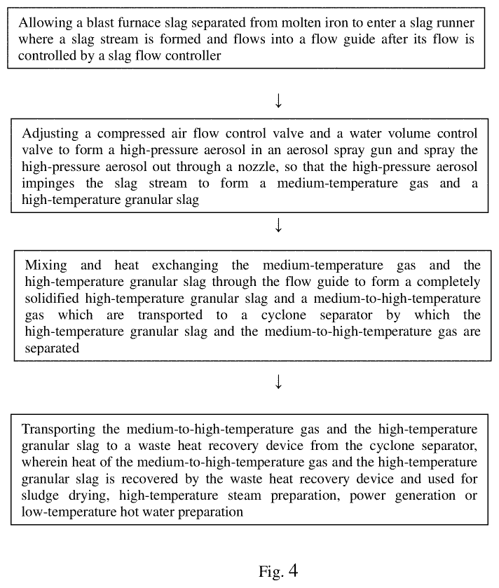

Referring to FIG. 4, a method for granulation of a blast furnace slag and recycling of waste heat comprises the following steps:

Step 1: allowing a blast furnace slag separated from molten iron to enter a slag runner where a slag stream 1 flows into a flow guide 7 after its flow is controlled by a slag flow controller 2;

Step 2: adjusting a compressed air flow control valve 3 and a water volume control valve 4 to form a high-pressure aerosol in an aerosol spray gun 5 and spray the high-pressure aerosol out through a nozzle, so that the high-pressure aerosol impinges the slag stream 1 flowing into the flow guide 7 to form a medium-temperature gas and a high-temperature granular slag 6 having a preliminarily solidified surface;

Step 3: mixing and heat exchanging the medium-temperature gas and the high-temperature granular slag 6 having a preliminarily solidified surface through the flow guide 7 to form a completely solidified high-temperature granular slag 6 and a medium-to-high-temperature gas which are transported to a cyclone separator 8 by which the high-temperature granular slag 6 and the medium-to-high-temperature gas are separated;

Step 4: transporting the medium-to-high-temperature gas and the high-temperature granular slag 6 to a waste heat recovery device from the cyclone separator 8, wherein the heat of the medium-to-high-temperature gas and the high-temperature granular slag 6 is recovered by the waste heat recovery device and used for sludge drying, high-temperature steam preparation, power generation or low-temperature hot water preparation.

The steps for the sludge drying include:

Step 4.1.1: pumping a wet sludge from a sludge tank 16 with a sludge pump 15 into a sludge pre-drier 14.

Step 4.1.2: mixing and reversely heat exchanging the wet sludge with the medium-to-high-temperature gas in the sludge pre-dryer 14 to form a semi-dry sludge.

In Step 4.1.2, the wet tail gas generated when the wet sludge is mixed with the medium-to-high-temperature gas is purified by the tail gas treatment module and then discharged.

Step 4.1.3: transporting the semi-dry sludge from the sludge pre-drying module to a screw mixer 9 and transporting the high-temperature granular slag 6 from the cyclone separator 8 to the screw mixer 9, wherein the semi-dry sludge and the high-temperature granular slag 6 are mixed by the screw mixer 9 to form a slag-sludge mixture.

Step 4.1.4: transporting the slag-sludge mixture from the screw mixer 9 to a sludge dryer 10, wherein the sludge dryer 10 dries the slag-sludge mixture into a dry sludge powder and slag granules which are transported to a slag-sludge recovery module.

In Step 4.1.4, the temperature of the slag granules is 200° C. or lower.

In Step 4.1.4, the wet tail gas generated when the slag-sludge mixture is dried by the sludge dryer 10 is purified by the tail gas treatment module and then discharged.

Step 4.1.5: separating the dry sludge powder from the slag granules in a slag-sludge separator 13 of the slag-sludge recovery module.

In Step 4.1.5, the wet tail gas generated when the dry sludge powder and the slag granules are separated by the sludge separator 13 is purified by the tail gas treatment module and then discharged.

Step 4.1.6: transporting the dry sludge powder from the sludge separator 13 to a dry sludge powder bin 12 for temporary storage.

Step 4.1.7: transporting the slag granules from the sludge separator 13 to a slag bin 11 for temporary storage.

The method for purifying and discharging the wet tail gas with the tail gas treatment module comprises: collecting and pretreating (such as cycloning to remove dust of millimeter-sized large particles) the wet tail gas from the sludge pre-dryer 14, the sludge dryer 10 and the slag-sludge separator 13 with a tail gas treatment device 17 of the tail gas treatment module, followed by deep purification with a tail gas purifier 18, wherein the up-to-standard purified tail gas is discharged through a chimney 20 by an exhauster 19; and the fine powder collected in the tail gas treatment device 17 and the tail gas purifier 18 is extracted out with an external tanker.

The steps for the high-temperature steam preparation include:

Step 4.2.1: transporting the high-temperature granular slag 6 from the cyclone separator 8 to a high-temperature granular slag conveyor 21 which lifts the high-temperature granular slag 6 and feeds it evenly to a high-temperature granular slag heat exchanger 22 from an upper inlet of the high-temperature granular slag heat exchanger 22, wherein the high-temperature granular slag 6 moves from top to bottom, and in the process of descending, it contacts and exchanges heat countercurrently with the cooling water in the coil and the air rising from bottom to top.

Step 4.2.2: discharging the heated high-temperature gas (300-600° C.) from the top of the high-temperature granular slag heat exchanger 22 and sending it to the boiler 23 and discharging the cooled granular slag from the lower part of the high-temperature granular slag heat exchanger to a slag bin 11. The temperature of the cooled slag is 200° C. or lower.

Step 4.2.3: sending the pure water supplied from an external pipe network to an economizer 24 to be preheated to 80° C. or higher by a low-to-medium-temperature tail gas (250° C. or lower) discharged from the boiler 23, wherein one part of the preheated pure water is sent to the boiler 23 to be further heated and vaporized into a high-temperature steam (200-250° C.), and the other part enters the coil of the high-temperature granular slag heat exchanger 22 to absorb the heat of the high-temperature granular slag 6.

Step 4.2.4: sending the water in the coil to a steam drum at an upper part of the boiler 23 after it is vaporized and heated to about 250° C., wherein it is mixed with the steam generated in the boiler 23 itself and then integrated into the external pipe network for use at the same level or for power generation.

The steps for the low-temperature hot water preparation include:

Step 4.3.1: transporting the high-temperature granular slag 6 from the cyclone separator 8 to a high-temperature granular slag conveyor 21 which lifts the high-temperature granular slag 6 and feeds it evenly to a high-temperature granular slag heat exchanger 22 from an upper inlet of the high-temperature granular slag heat exchanger 22, wherein the high-temperature granular slag 6 moves from top to bottom, and in the process of descending, it contacts and exchanges heat countercurrently with the cooling water in the coil and the air rising from bottom to top.

Step 4.3.2: discharging the heated low-temperature hot water (70-95° C.) from the top of the high-temperature granular slag heat exchanger 22 and sending it to the boiler 23 and discharging the cooled granular slag from the lower part of the high-temperature granular slag heat exchanger to a slag bin 11. The temperature of the cooled slag is 200° C. or lower.

Step 4.3.3: sending one part of the pure water supplied from an external pipe network to the boiler 23 to be heated to 70-95° C. by a medium-to-high-temperature gas (300-600° C.) passing through the boiler 23 and sending the other part to the coil of the high-temperature granular slag heat exchanger 22 to absorb the heat of the high-temperature granular slag 6.

Step 4.3.4: sending the water in the coil to a steam drum at an upper part of the boiler 23 after it is heated by absorbing the heat, wherein it is mixed with the hot water generated in the boiler 23 itself and then integrated into the external pipe network for use as domestic water or for a cooling purpose.

### EXAMPLE 1

Referring to FIG. 1, when the blast furnace is tapping, the blast furnace slag enters the main runner along with the molten iron from the taphole and is intercepted by the slag stopper. The slag having a temperature of 1450-1550° C. is separated from the molten iron, and enters the slag runner. Then, the slag enters an aerosol granulation nozzle module to be granulated. Particularly, the slag stream 1 flows out after its flow is controlled by a slag flow controller 2. After leaving the slag stream controller 2, the slag stream 1 is blown, granulated and preliminarily cooled by the high-pressure aerosol sprayed by the aerosol gun 5 during its falling to form a high-temperature granular slag 6 having a temperature of 1000-1200° C. and a medium-temperature gas having a temperature of 200-400° C. The flow rate of the high-pressure aerosol is determined by the compressed air flow control valve 3 and the water volume control valve 4, and is automatically adjusted within a certain range depending on the volume of the slag stream 1. The medium-temperature gas stream entraining the granulated high-temperature granular slag 6 is guided by the flow guide 7 to a waste heat recovery device. The medium-temperature gas and the high-temperature granular slag 6 are further mixed and exchange heat while they are passing through the flow guide 7. The temperature of the gas rises to 300-500° C. to form a medium-to-high-temperature gas, and the temperature of the high-temperature granular slag 6 drops to 900-1100° C. The high-temperature granular slag 6 is completely solidified. The aerosol-based slag granulation technology combines the advantages of the gas quenching-based slag granulation technology and the water quenching-based slag granulation technology. The granular slag having a high vitrification rate retains the resource nature of a water quenched slag, and the dry granular slag reduces the micronization cost and the environmental impact during transportation. The high-temperature granular slag and the medium-to-high-temperature gas stream generated in the granulation process create favorable conditions for recycling thermal energy.

The medium-to-high-temperature gas and the high-temperature granular slag 6 enter the cyclone separator 8. The cyclone separator 8 has a highly effective separation capability and can separate the vast majority of the high-temperature granular slag 6 from the medium-to-high-temperature gas. The medium-to-high-temperature gas is led out from the upper part of the rotary separator 8 and enters the sludge pre-dryer 14 in which reverse contact and heat exchange occur between the medium-to-high-temperature gas and the wet sludge (converter sludge obtained by wet dedusting and having a water content of 60-90 wt %, i.e. OG sludge) pumped by the sludge pump 15. The water content of the sludge drops to about 50%, and the gas temperature drops to 200° C. The 800-950° C. high-temperature granular slag 6 collected by the cyclone separator 8 and the semi-dry sludge from the sludge pre-dryer 14 are stirred and mixed under the action of the screw mixer 9. The slag-sludge mixture is sent directly to the sludge dryer 10. The slag and the sludge contact and exchange heat directly in the sludge dryer 10. The mixing ratio of the slag to the sludge is 2:1-3:1. The sludge is dried to the set moisture index (e.g., 6%). The temperature of the slag granules drops to 200° C. or lower. After drying, the dry sludge powder and the granular slag are separated by the slag-sludge separator 13, and sent to the temporary bins, namely the slag bin 11 and the dry sludge powder bin 12, waiting for outbound transportation for subsequent resource utilization.

The temperature of the wet tail gas produced by the sludge pre-dryer 14, the sludge dryer 10 and the slag-sludge separator 13 is controlled to be 200° C. or higher. The wet tail gas is subjected to cyclone treatment by the tail gas treatment device 17 to remove the dust of millimeter-sized large particles. The temperature of the tail gas drops to 150-200° C. After deep purification by the tail gas purifier 18 to remove at least 95% of various types of fine dust, the tail gas is pressurized by the exhauster 19, and discharged through the chimney 20 up to the standard. The tail gas purifier 18 may be a cloth bag or an electrostatic deduster.

The fine powder collected by the tail gas treatment device 17 and the tail gas purifier 18 is regularly extracted out with a tanker and sent directly to a subsequent unit for use.

### EXAMPLE 2

Referring to FIG. 2, when the blast furnace is tapping, the blast furnace slag enters the main runner along with the molten iron from the taphole, and is intercepted by the slag stopper. The slag having a temperature of 1450-1550° C. is separated from the molten iron, and enters the slag runner. Then, the slag enters an aerosol granulation nozzle module to be granulated. Particularly, the slag stream 1 flows out after its flow is controlled by a slag flow controller 2. After leaving the slag stream controller 2, the slag stream 1 is blown, granulated and preliminarily cooled by the high-pressure aerosol sprayed by the aerosol gun 5 during its falling to form a high-temperature granular slag 6 having a temperature of 1000-1200° C. and a medium-temperature gas having a temperature of 200-400° C. The flow rate of the high-pressure aerosol is determined by the compressed air flow control valve 3 and the water volume control valve 4, and is automatically adjusted within a certain range depending on the volume of the slag stream 1. The medium-temperature gas stream entraining the granulated high-temperature granular slag 6 is guided by the flow guide 7 to a waste heat recovery device. The medium-temperature gas and the high-temperature granular slag 6 are further mixed and exchange heat while they are passing through the flow guide 7. The temperature of the gas rises to 300-500° C. to form a medium-to-high-temperature gas, and the temperature of the high-temperature granular slag 6 drops to 800-1100° C. The high-temperature granular slag 6 is completely solidified. The aerosol-based slag granulation technology combines the advantages of the gas quenching-based slag granulation technology and the water quenching-based slag granulation technology. The granular slag having a high vitrification rate retains the resource nature of a water quenched slag, and the dry granular slag reduces the micronization cost and the environmental impact during transportation. The high-temperature granular slag and the medium-to-high-temperature gas stream generated in the granulation process create favorable conditions for recycling thermal energy.

The medium-to-high-temperature gas and the high-temperature granular slag 6 enter the cyclone separator 8. The cyclone separator 8 has a highly effective separation capability and can separate the vast majority of the high-temperature granular slag 6 from the medium-to-high-temperature gas. The 700-950° C. high-temperature granular slag 6 separated from the cyclone separator 8 is transported to the upper part of the high-temperature granular slag heat exchanger 22 through the high-temperature feed conveyor 21. The high-temperature granular slag 6 descends slowly in the high-temperature granular slag heat exchanger 22, and as it descends, undergoes reverse heat exchange with the circulating water in the coil and the gas stream rising from the lower part. The high-temperature granular slag is cooled to about 200° C. and then sent to the slag bin 11 below. The rising gas stream is heated to 300-600° C., discharged from the top of the high-temperature granular slag heat exchanger 22, merged with the medium-to-high-temperature gas stream discharged from the cyclone separator 8, and then sent to the boiler 23.

The pure water sent from the external pipe network passes through the economizer 24 first and is preheated to 80° C. or higher by the low-to-medium-temperature tail gas discharged from the boiler 23. After the pure water is degassed, one part of it is sent to the boiler 23 to be heated and vaporized by 300-600° C. hot air into 200-250° C. steam, and the other part enters the heat exchange coil in the high-temperature granular slag heat exchanger 22. This part of the water absorbs the heat of the high-temperature granular slag 6 directly. After its temperature rises to about 250° C., it enters the steam drum at the upper part of the boiler 23, wherein it is mixed with the steam generated by the boiler itself and then integrated into the external pipe network for use at the same level or for power generation.

The temperature of the wet tail gas discharged from the economizer 24 is controlled to be 200° C. or higher. The wet tail gas is subjected to cyclone treatment by the tail gas treatment device 17 to remove the dust of millimeter-sized large particles. The temperature of the tail gas drops to 150-200° C. After deep purification by the tail gas purifier 18, the dust content is less than 10 mg. Finally, the tail gas is pressurized by the exhauster 19 and discharged through the chimney 20 up to the standard.

The small amount of fine powder collected by the tail gas treatment device 17 and the tail gas purifier 18 is regularly extracted out with a tanker and sent directly to a subsequent unit for use.

### EXAMPLE 3

Referring to FIG. 3, when the blast furnace is tapping, the blast furnace slag enters the main runner along with the molten iron from the taphole and is intercepted by the slag stopper. The slag having a temperature of 1450-1550° C. is separated from the molten iron and enters the slag runner. Then, the slag enters an aerosol granulation nozzle module to be granulated. Particularly, the slag stream 1 flows out after its flow is controlled by a slag flow controller 2. After leaving the slag stream controller 2, the slag stream 1 is blown, granulated and preliminarily cooled by the high-pressure aerosol sprayed by the aerosol gun 5 during its falling to form a high-temperature granular slag 6 having a temperature of 1000-1200° C. and a medium-temperature gas having a temperature of 200-400° C. The flow rate of the high-pressure aerosol is determined by the compressed air flow control valve 3 and the water volume control valve 4 and is automatically adjusted within a certain range depending on the volume of the slag stream 1. The medium-temperature gas entraining the granulated high-temperature granular slag 6 is guided by the flow guide 7 to a waste heat recovery module. The medium-temperature gas and the high-temperature granular slag 6 are further mixed and exchange heat while they are passing through the flow guide 7. The temperature of the gas rises to 300-500° C. to form a medium-to-high-temperature gas. The temperature of the high-temperature granular slag 6 drops to 800-1100° C., and the high-temperature granular slag 6 is completely solidified. The aerosol-based slag granulation technology combines the advantages of the gas quenching-based slag granulation technology and the water quenching-based slag granulation technology. The granular slag having a high vitrification rate retains the resource nature of a water quenched slag, and the dry granular slag reduces the micronization cost and the environmental impact during transportation. The high-temperature granular slag and the medium-temperature gas stream generated in the granulation process create favorable conditions for recycling thermal energy.

The medium-to-high-temperature gas and the high-temperature granular slag 6 enter the cyclone separator 8. The cyclone separator 8 has a highly effective separation capability and can separate the vast majority of the high-temperature granular slag 6 from the medium-to-high-temperature gas. The 700-950° C. high-temperature granular slag 6 separated from the cyclone separator 8 is transported to the upper part of the high-temperature granular slag heat exchanger 22 through the high-temperature feed conveyor 21. The high-temperature granular slag 6 descends slowly in the high-temperature granular slag heat exchanger 22, and as it descends, undergoes reverse heat exchange with the circulating water in the coil and the gas stream rising from the lower part. The high-temperature granular slag is cooled to about 200° C. and then sent to the slag bin 11 below. The rising gas stream is heated to 300-600° C., discharged from the top of the heat exchanger 22, merged with the medium-to-high-temperature gas stream discharged from the cyclone separator 8, and then enters the boiler 23.

One part of the pure water sent from the external pipe network is sent to the boiler 23 to be heated by 300-600° C. hot air into 70-95° C. hot water, and the other part enters the heat exchange coil in the high-temperature granular slag heat exchanger 22. This part of the water absorbs the heat of the high-temperature granular slag 6 directly. After its temperature rises to about 70-95° C., it enters the upper part of the boiler 23, wherein it is mixed with the hot water generated by the boiler itself and then integrated into the external pipe network for use as domestic water or for a cooling purpose.

The temperature of the wet tail gas discharged from the boiler 23 is controlled to be 200° C. or higher. The wet tail gas is subjected to cyclone treatment by the tail gas treatment device 17 to remove the dust of millimeter-sized large particles. The temperature of the tail gas drops to 150-200° C. After deep purification by the tail gas purifier 18, the dust content is less than 10 mg. Finally, the tail gas is pressurized by the exhauster 19 and discharged through the chimney 20 up to the standard.

The small amount of fine powder collected by the tail gas treatment device 17 and the tail gas purifier 18 is regularly extracted out with a tanker and sent directly to a subsequent unit for use.

The above description only reveals some preferred embodiments of the disclosure, with no intention to limit the protection scope of the disclosure. Therefore, all changes, equivalents, modifications within the spirit and principles of the disclosure are included in the protection scope of the disclosure.

1. An apparatus for granulation of a blast furnace slag and recycling of waste heat, wherein the apparatus comprises an aerosol granulation nozzle module, a flow guide (7), a cyclone separator (8) and a waste heat recovery device;
wherein the aerosol granulation nozzle module comprises a slag flow controller (2), a compressed air flow control valve (3), a water volume control valve (4) and an aerosol spray gun (5); wherein the slag flow controller (2) is coupled to a slag inlet of the flow guide (7); the compressed air flow control valve (3) is coupled to a gas inlet of the aerosol spray gun (5); the water volume control valve (4) is coupled to a liquid inlet of the aerosol spray gun (5); wherein a nozzle of the aerosol spray gun (5) is configured to face an inlet of the flow guide (7) to enable an aerosol to impinge a slag stream entering the flow guide (7) through the slag flow controller (2) to form a medium-temperature gas and a high-temperature granular slag (6) having a primarily solidified surface;
wherein the flow guide (7) is configured to fully mix the medium-temperature gas and the high-temperature granular slag (6) having a primarily solidified surface in the flow guide, wherein an outlet of the flow guide (7) is coupled to a feed port of the cyclone separator (8) to allow for entry of a completely solidified high-temperature granular slag (6) and a medium-to-high-temperature gas formed in the flow guide (7) into the cyclone separator (8);
wherein the cyclone separator (8) is configured to separate the high-temperature granular slag (6) and the medium-to-high-temperature gas; wherein a discharge port of the cyclone separator (8) is coupled to a feed port of the waste heat recovery device for delivery of the medium-to-high-temperature gas and the completely solidified high-temperature granular slag (6) to the waste heat recovery device.

2. The apparatus for granulation of a blast furnace slag and recycling of waste heat according to claim 1, wherein a slag stream (1) is subjected to flow control by the slag flow controller (2) and flows into a slag inlet of the flow guide (7); a high pressure gas is directed to the gas inlet of the aerosol spray gun (5) through the compressed air flow control valve (3); water is directed to the liquid inlet of the aerosol spray gun (5) through the water volume control valve (4); wherein the nozzle of the aerosol spray gun (5) is configured to face the inlet of the flow guide (7) to enable an aerosol to impinge the slag stream (1) to form a medium-temperature gas and a high-temperature granular slag (6) having a primarily solidified surface.

3. The apparatus for granulation of a blast furnace slag and recycling of waste heat according to claim 1, wherein after formed by impinging the aerosol from the aerosol granulation nozzle module on the slag stream (1), the medium-temperature gas has a temperature of 200-400° C., and the high-temperature granular slag (6) having a preliminarily solidified surface has a temperature of 1000-1200° C.; wherein after mixed in the flow guide (7), the medium-to-high temperature gas has a temperature of 300-500° C., and the completely solidified high-temperature granular slag (6) has a temperature of 800-1100° C.; wherein after separated by the cyclone separator (8), the high-temperature granular slag (6) has a temperature of 700-950° C., and the medium-to-high temperature gas has a temperature of 350-550° C.

4. The apparatus for granulation of a blast furnace slag and recycling of waste heat according to claim 1, wherein the waste heat recovery device is a sludge drying module comprising a screw mixer (9), a sludge dryer (10), a sludge pre-drying module, a slag-sludge recovery module and a tail gas treatment module; wherein the discharge port of the cyclone separator (8) is coupled to a first feed port of the screw mixer (9) to transport the completely solidified high-temperature granular slag (6) into the screw mixer (9); wherein an aerosol port of the cyclone separator (8) is coupled to an aerosol port of the sludge pre-drying module to transport the medium-to-high-temperature gas into the sludge pre-drying module, so that the medium-to-high-temperature gas is mixed with a wet sludge in the sludge pre-drying module to form a semi-dry sludge; wherein a discharge port of the sludge pre-drying module is coupled to a second feed port of the screw mixer (9) to transport the semi-dry sludge into the screw mixer (9), so that the semi-dry sludge and the high-temperature granular slag (6) are mixed in the screw mixer (9) to form a slag-sludge mixture; wherein a discharge port of the screw mixer (9) is coupled to a feed port of the sludge dryer (10) to transport the slag-sludge mixture into the sludge dryer (10); wherein a discharge port of the sludge dryer (10) is coupled to a feed port of the slag-sludge recovery module to transport a dry sludge powder and slag granules into the slag-sludge recovery module; wherein a gas inlet of the tail gas treatment module is coupled to a gas outlet of the sludge pre-drying module, a gas outlet of the sludge dryer (10) and a gas outlet of the slag-sludge recovery module.

5. The apparatus for granulation of a blast furnace slag and recycling of waste heat according to claim 1, wherein the waste heat recovery device is a high-temperature steam preparation module, wherein the high-temperature steam preparation module is coupled to the cyclone separator (8) to recover heat of the medium-to-high-temperature gas and the high-temperature granular slag (6) to prepare a high-temperature steam having a temperature of 200-250° C.; wherein a tail gas outlet of the high-temperature steam preparation module is coupled to a tail gas treatment module.

6. The apparatus for granulation of a blast furnace slag and recycling of waste heat according to claim 5, wherein the high-temperature steam preparation module comprises a slag bin (11), a tail gas treatment device (17), a gas purifier (18), an exhauster (19), a chimney (20), a high-temperature feed conveyor (21), a high-temperature granular slag heat exchanger (22), a boiler (23) and an economizer (24);
wherein the high-temperature feed conveyor (21) is provided between the discharge port of the cyclone separator (8) and a feed port of the high-temperature granular slag heat exchanger (22) to transport the high-temperature granular slag (6) separated by the cyclone separator (8) to an upper part of the high-temperature granular slag heat exchanger (22); a coil containing circulating water is provided in the high-temperature granular slag heat exchanger (22) for reverse heat exchange of the coil and a gas stream rising from bottom to top with the high-temperature granular slag (6); the slag bin (11) is provided under a discharge port located at a bottom of the high-temperature granular slag heat exchanger (22) to receive the granular slag after cooling; a top of the high-temperature granular slag heat exchanger (22) is provided with a gas port which is coupled to the boiler (23); the economizer (24) is coupled to the boiler (23) and the high-temperature granular slag heat exchanger (22) respectively, so that pure water sent to the economizer (24) through an external pipe network is preheated to 80° C. or higher by a tail gas emitted from the boiler (23), and divided into two parts, one part being sent into the boiler (23), and the other part entering the coil of the high-temperature granular slag heat exchanger (22) to absorb heat of the high-temperature granular slag (6); wherein a gas inlet of the tail gas treatment device (17) is coupled to a tail gas outlet of the economizer (24), a gas outlet of the tail gas treatment device (17) is coupled to a gas inlet of the tail gas purifier (18), and a gas outlet of the tail gas purifier (18) is coupled to the chimney (20) through the exhauster (19) for purification and discharge of the tail gas.

7. The apparatus for granulation of a blast furnace slag and recycling of waste heat according to claim 6, wherein when the water in the coil vaporizes and its temperature rises to about 250° C., it enters a steam drum at an upper part of the boiler (23), wherein it is mixed with steam generated by the boiler (23) itself and incorporated into the external pipe network.

8. The apparatus for granulation of a blast furnace slag and recycling of waste heat according to claim 1, wherein the waste heat recovery device is a low-temperature hot water preparation module, wherein the low-temperature hot water preparation module is coupled to the cyclone separator (8) to recover heat of the medium-to-high-temperature gas and the high-temperature granular slag (6) to prepare low-temperature hot water having a temperature of 70-95° C.; wherein a tail gas outlet of the low-temperature hot water preparation module is coupled to a tail gas treatment module.

9. The apparatus for granulation of a blast furnace slag and recycling of waste heat according to claim 8, wherein the low-temperature hot water preparation module comprises a slag bin (11), a tail gas treatment device (17), a gas purifier (18), an exhauster (19), a chimney (20), a high-temperature feed conveyor (21), a high-temperature granular slag heat exchanger (22) and a boiler (23);
wherein the high-temperature feed conveyor (21) is provided between the discharge port of the cyclone separator (8) and a feed port of the high-temperature granular slag heat exchanger (22) to transport the high-temperature granular slag (6) separated by the cyclone separator (8) to an upper part of the high-temperature granular slag heat exchanger (22); a coil containing circulating water is provided in the high-temperature granular slag heat exchanger (22) for reverse heat exchange of the high-temperature granular slag (6) with the coil and a gas stream rising from bottom to top; the slag bin (11) is provided under a discharge port located at a bottom of the high-temperature granular slag heat exchanger (22) to receive the granular slag after cooling; a top of the high-temperature granular slag heat exchanger (22) is provided with a gas port which is coupled to the boiler (23); the boiler (23) and the high-temperature granular slag heat exchanger (22) are coupled to an external pipe network respectively to receive pure water for heat exchange in the boiler (23) and the high-temperature granular slag heat exchanger (22); wherein a gas inlet of the tail gas treatment device (17) is coupled to a tail gas outlet of the boiler (23), a gas outlet of the tail gas treatment device (17) is coupled to a gas inlet of the tail gas purifier (18), and a gas outlet of the tail gas purifier (18) is coupled to the chimney (20) through the exhauster (19) for purification and discharge of the tail gas.

10. The apparatus for granulation of a blast furnace slag and recycling of waste heat according to claim 4, wherein the tail gas treatment module comprises a tail gas treatment device (17), a tail gas purifier (18), an exhauster (19) and a chimney (20), wherein a gas inlet of the tail gas treatment device (17) is coupled to the gas outlet of the sludge pre-drying module, the gas outlet of the sludge dryer (10), and the gas outlet of the slag-sludge recovery module through pipes respectively, wherein a gas outlet of the tail gas treatment device (17) is coupled to a gas inlet of the tail gas purifier (18), wherein a gas outlet of the tail gas purifier (18) is coupled to the chimney (20) through the exhauster (19).

11. A method for granulation and waste heat recycling using the apparatus according to-claim 1, wherein the method comprises the following steps:
allowing a blast furnace slag separated from molten iron to enter a slag runner where a slag stream (1) is formed and flows into a flow guide (7) after its flow is controlled by a slag flow controller (2);
adjusting a compressed air flow control valve (3) and a water volume control valve (4) to form a high-pressure aerosol in an aerosol spray gun (5) and spray the high-pressure aerosol out through a nozzle, so that the high-pressure aerosol impinges the slag stream (1) flowing into the flow guide (7) to form a medium-temperature gas and a high-temperature granular slag (6) having a preliminarily solidified surface;
mixing and heat exchanging the medium-temperature gas and the high-temperature granular slag (6) having a preliminarily solidified surface through the flow guide (7) to form a completely solidified high-temperature granular slag (6) and a medium-to-high-temperature gas which are transported to a cyclone separator (8) by which the high-temperature granular slag (6) and the medium-to-high-temperature gas are separated; and
transporting the medium-to-high-temperature gas and the high-temperature granular slag (6) to a waste heat recovery device from the cyclone separator (8), wherein heat of the medium-to-high-temperature gas and the high-temperature granular slag (6) is recovered by the waste heat recovery device and used for sludge drying, high-temperature steam preparation, power generation or low-temperature hot water preparation.

12. The method according to claim 11, wherein after formed by impinging the aerosol from the aerosol granulation nozzle module on the slag stream (1), the medium-temperature gas has a temperature of 200-400° C., and the high-temperature granular slag (6) having a preliminarily solidified surface has a temperature of 1000-1200° C.; wherein after mixed in the flow guide (7), the medium-to-high temperature gas has a temperature of 300-500° C., and the completely solidified high-temperature granular slag (6) has a temperature of 800-1100° C.; wherein after separated by the cyclone separator (8), the high-temperature granular slag (6) has a temperature of 700-950° C., and the medium-to-high temperature gas has a temperature of 350-550° C.

13. The method according to claim 11, wherein the step of sludge drying comprises:
pumping a wet sludge from a sludge tank (16) with a sludge pump (15) into a sludge pre-drier (14);
mixing and reversely heat exchanging the wet sludge with the medium-to-high-temperature gas in the sludge pre-dryer (14) to form a semi-dry sludge;
transporting the semi-dry sludge from the sludge pre-drying module to a screw mixer (9), and transporting the high-temperature granular slag (6) from the cyclone separator (8) to the screw mixer (9), wherein the semi-dry sludge and the high-temperature granular slag (6) are mixed by the screw mixer (9) to form a slag-sludge mixture;
transporting the slag-sludge mixture from the screw mixer (9) to a sludge dryer (10), wherein the sludge dryer (10) dries the slag-sludge mixture into a dry sludge powder and slag granules which are transported to a slag-sludge recovery module;
separating the dry sludge powder from the slag granules in a slag-sludge separator (13) of the slag-sludge recovery module;
transporting the dry sludge powder from the sludge separator (13) to a dry sludge powder bin (12) for temporary storage; and
transporting the slag granules from the sludge separator (13) to a slag bin (11) for temporary storage;
wherein the method further comprises purifying and discharging a wet tail gas with a tail gas treatment module, including: collecting and pretreating the wet tail gas from the sludge pre-dryer (14), the sludge dryer (10) and the slag-sludge separator (13) with a tail gas treatment device (17) of the tail gas treatment module, followed by deep purification with a tail gas purifier (18), wherein the tail gas purified up to standard is discharged through a chimney (20) by an exhauster (19); and the fine powder collected in the tail gas treatment device (17) and the tail gas purifier (18) is extracted out with an external tanker.

14. The method according to claim 11, wherein the step of high-temperature steam preparation comprises:
transporting the high-temperature granular slag (6) from the cyclone separator (8) to a high-temperature granular slag conveyor (21) which lifts the high-temperature granular slag (6) and feeds it to a high-temperature granular slag heat exchanger (22) from an upper inlet of the high-temperature granular slag heat exchanger (22), wherein the high-temperature granular slag (6) moves from top to bottom, and in the process of descending, it contacts and exchanges heat countercurrently with cooling water in a coil and air rising from bottom to top;
discharging the heated steam from a top of the high-temperature granular slag heat exchanger (22) and sending it to a boiler (23), and discharging the cooled granular slag from a lower part of the high-temperature granular slag heat exchanger to a slag bin (11);
sending pure water supplied from an external pipe network to an economizer (24) to be preheated to 80° C. or higher by a tail gas discharged from the boiler (23), wherein one part of the pure water is sent to the boiler (23) to be further heated and vaporized into steam having a temperature of 200-250° C., and the other part enters the coil of the high-temperature granular slag heat exchanger (22) to absorb heat of the high-temperature granular slag (6); and
sending the water in the coil to a steam drum at an upper of the boiler (23) after it is vaporized and heated to about 250° C., wherein it is mixed with steam generated in the boiler (23) itself and then integrated into the external pipe network.

15. The method according to claim 11, wherein the step of low-temperature hot water preparation comprises:
transporting the high-temperature granular slag (6) from the cyclone separator (8) to a high-temperature granular slag conveyor (21) which lifts the high-temperature granular slag (6) and feeds it to a high-temperature granular slag heat exchanger (22) from an upper inlet of the high-temperature granular slag heat exchanger (22), wherein the high-temperature granular slag (6) moves from top to bottom, and in the process of descending, it contacts and exchanges heat countercurrently with cooling water in a coil and air rising from bottom to top;
discharging the heated low-temperature hot water having a temperature of 70-95° C. from a top of the high-temperature granular slag heat exchanger (22) and sending it to a boiler (23), and discharging the cooled granular slag from a lower part of the high-temperature granular slag heat exchanger to a slag bin (11);
sending one part of pure water from an external pipe network to the boiler (23) to be heated to 70-95° C. by a gas passing through the boiler (23), and sending the other part to the coil of the high-temperature granular slag heat exchanger (22) to absorb heat of the high-temperature granular slag (6); and
sending the water in the coil to a steam drum at an upper part of the boiler (23) after it is heated by absorbing the heat, wherein it is mixed with hot water generated in the boiler (23) itself and then integrated into the external pipe network.
